(19) United States
(12) Patent Application Publication
(10) Pub. No.: US 2018/0237269 A1
(43) Pub. Date: Aug. 23, 2018

(54) ROPELESS ELEVATOR SYSTEM MODULAR INSTALLATION

(71) Applicant: OTIS ELEVATOR COMPANY, Farmington, CT (US)

(72) Inventors: Tadeusz Pawel Witczak, Farmington, CT (US); Richard J. Ericson, Southington, CT (US)

(21) Appl. No.: 15/435,853

(22) Filed: Feb. 17, 2017

(51) Int. Cl. B66B 19/00; B66B 9/00; B66B 11/04

(52) U.S. Cl. CPC B66B 19/00; B66B 11/0407; B66B 9/003

(57) ABSTRACT

An elevator system for a building having a plurality of floors includes a hoistway having one or more lanes. The one or more lanes are defined by a plurality of modules. Each of the plurality of modules is associated with at least one of the plurality of floors. The plurality of modules is stacked relative to one another. Each of the plurality of modules is installable within the building prior to construction of the at least one floor associated therewith, at the same time as construction of the at least one floor associated therewith, or after construction of the at least one floor associated therewith.

### BACKGROUND

The subject matter disclosed herein relates generally to the field of elevators, and more particularly to modular installation of a multicar, ropeless, self-propelled elevator system.

Ropeless elevator systems, also referred to as self-propelled elevator systems, are useful in certain applications (e.g., high rise buildings) where there is a desire for multiple elevator cars to travel in a single hoistway or lane. There exist ropeless elevator systems in which a first lane is designated for upward traveling elevator cars and a second lane is designated for downward traveling elevator cars. A transfer station at each end of the lane is used to move cars horizontally between the first lane and second lane.

Installation of conventional elevators including both elevator systems with machine rooms and machine room-less systems entail lifting equipment, including the drive machine, into a position at the top of the hoistway. Similarly, installation of the tension members associated with a conventional elevator system requires lifting and aligning ropes or belts. As a result, installation of conventional elevator systems may be time consuming and prevent the elevator from being used until the structure surrounding the hoistway is completed.

### BRIEF DESCRIPTION

According to embodiment, an elevator system for a building having a plurality of floors includes a hoistway having one or more lanes. The one or more lanes are defined by a plurality of modules. Each of the plurality of modules is associated with at least one of the plurality of floors. The plurality of modules are stacked relative to one another. Each of the plurality of modules is installable within the building prior to construction of the at least one floor associated therewith, at the same time as construction of the at least one floor associated therewith, or after construction of the at least one floor associated therewith.

In addition to one or more of the features described above, or as an alternative, in further embodiments each of said plurality of modules is associated with a single floor of said plurality of floors.

In addition to one or more of the features described above, or as an alternative, in further embodiments each of said plurality of modules is associated with two or more floors of said plurality of floors.

In addition to one or more of the features described above, or as an alternative, further embodiments may include at least one elevator car moveable within said one or more lanes.

In addition to one or more of the features described above, or as an alternative, in further embodiments said at least one elevator car is moveable in a single vertical direction within at least one of said one or more lanes.

In addition to one or more of the features described above, or as an alternative, further embodiments may include a propulsion system for moving said at least one elevator car within said at least one lane. The propulsion system includes a primary portion mounted within said hoistway and a secondary portion coupled to said at least one elevator car, wherein said primary portion is positioned within the hoistway via said plurality of substantially aligned modules.

In addition to one or more of the features described above, or as an alternative, in further embodiments said at least one elevator car is movable within an installed portion of said plurality of modules during construction of the elevator system, said installed portion including less than said entire plurality of modules.

In addition to one or more of the features described above, or as an alternative, in further embodiments said plurality of modules includes at least one transfer station module and at least one lane module.

In addition to one or more of the features described above, or as an alternative, in further embodiments each of said plurality of modules includes a structural frame, a portion of said structural frame being a temporary structure.

In addition to one or more of the features described above, or as an alternative, in further embodiments each of said plurality of modules includes a structural frame, a portion of said structural frame being a permanent structure affixed directly to a structure of the building.

According to another embodiment, a module for constructing a lane of an elevator system in a building includes a plurality of vertically and horizontally extending members connected to form a structural frame of a predetermined size. At least one alignment feature is associated with said structural frame. The at least one alignment feature is configured to align the module within a hoistway of the elevator system. At least one feature is associated with a propulsion system, a control system, a guidance system, and a power system of the elevator system.

In addition to one or more of the features described above, or as an alternative, in further embodiments said at least one feature of the module is shared with an adjacent module.

In addition to one or more of the features described above, or as an alternative, in further embodiments said at least one feature includes a component arranged at a predetermined position relative to said structural frame.

In addition to one or more of the features described above, or as an alternative, in further embodiments said at least one feature indicates a position for installing one or more components associated with the elevator system relative to the structural frame.

A method of installing an elevator system having a lane defined by a plurality of modules within a building includes installing a portion of the plurality of modules within the building. The portion of the plurality of modules includes at least one lane module and at least one transfer station module. The portion of the plurality of modules is substantially aligned. At least one elevator car is installed within the installed portion of the plurality of modules. The at least one elevator car is moved through the installed portion of the plurality of modules.

In addition to one or more of the features described above, or as an alternative, in further embodiments moving said at least one elevator car from within the installed portion of the plurality of modules into a parking area arranged adjacent the lane.

These and other advantages and features will become more apparent from the following description taken in conjunction with the drawings.

### BRIEF DESCRIPTION OF THE DRAWINGS

The subject matter of this disclosure is particularly pointed out and distinctly claimed in the claims at the conclusion of the specification. The foregoing and other features, and advantages are apparent from the following detailed description taken in conjunction with the accompanying drawings in which:

FIG. 1 illustrates a multicar ropeless elevator system according to one aspect of the disclosure;

FIG. 2 is a schematic illustration of one car of the multicar ropeless elevator system;

FIG. 3 is a perspective view of a building including a multicar ropeless elevator system during construction according to an embodiment; and

FIG. 4 is a perspective view of a module for use during construction of an elevator system according to an embodiment.

The detailed description explains embodiments, together with advantages and features, by way of example with reference to the drawings.

### DETAILED DESCRIPTION

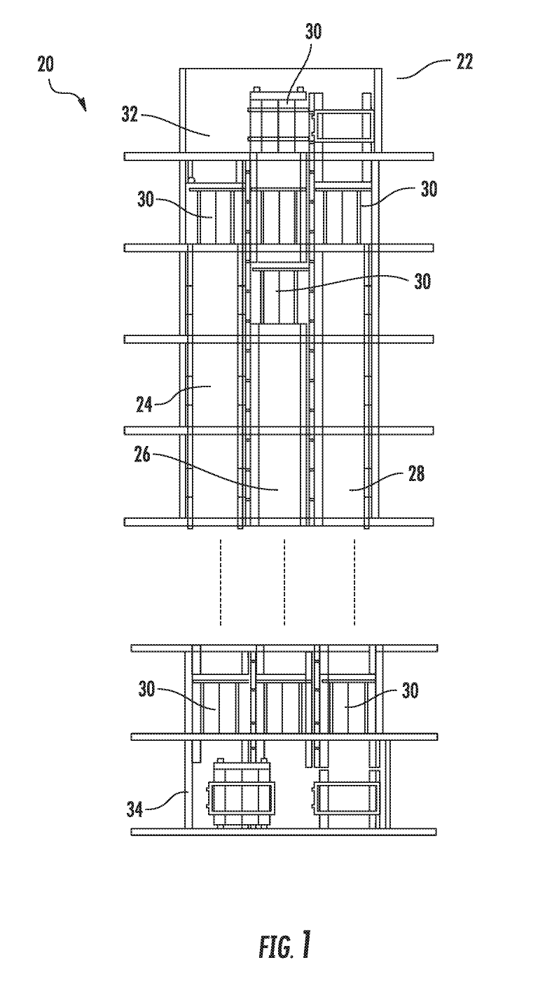

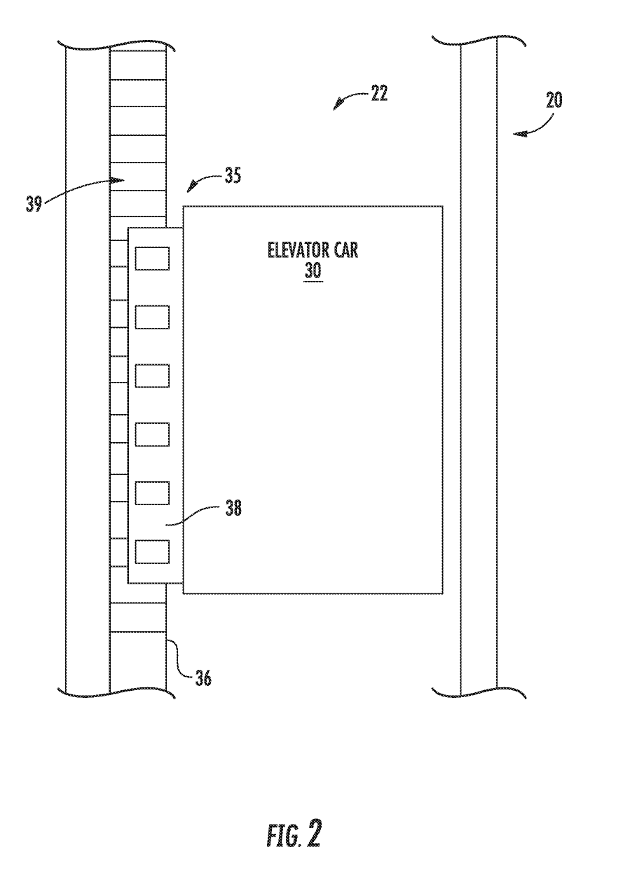

Referring to FIGS. 1 and 2, an example of a multicar, ropeless elevator system 20 is illustrated according to an embodiment. Elevator system 20 includes a hoistway 22 having a plurality of lanes 24, 26, 28. While three lanes are shown (FIG. 1), it is understood that embodiments of the multicar, ropeless elevator system having any number of lanes are within the scope of the disclosure. In each lane 24, 26, 28, cars 30 are configured to travel in one direction, i.e., up or down. For example, in FIG. 1, within lanes 24 and 28, elevator cars travel vertically upward and within lane 26, elevator cars 30 travel vertically downward. As shown, one or more cars 30 may travel in a single lane 24, 26, and 28.

Located generally above the top floor is an upper transfer station 32 configured to impart horizontal motion to elevator cars 30 to move elevator cars 30 between lanes 24, 26, and 28. It is understood that upper transfer station 32 may be located at the top floor, rather than above the top floor. Alternatively, or in addition, a lower transfer station 34 configured to impart horizontal motion to elevator cars 30 to move elevator cars 30 between lanes 24, 26, and 28 is located below the first floor of the building. It is understood that lower transfer station 34 may be located at the first floor, rather than below the first floor. Although not shown in FIG. 1, one or more intermediate transfer stations may be used between the lower and the upper transfer station floors. Intermediate transfer stations are similar to the upper transfer station 32 and lower transfer station 34.

Turning to FIG. 2, cars 30 are self-propelled using, for example, a linear propulsion system 35 having a fixed or stationary portion 36 and a moving portion 38. One or more fixed portions 36 are mounted at one side, or on opposing sides of lanes 24, 26, and 28. Fixed portion 36 may include coils that are energized by one or more drives to produce magnetic flux. Moving portion 38 may include permanent magnets that cooperate with the coils 26 to impart a force on the car 30. One or more moving portions 38 are mounted on cars 30, such as on one side or on two sides of the cars 30 for example. One of the portions of the linear motor system, such as the fixed portion 36 for example, is supplied with drive signals to control movement of cars 30 within their respective lanes.

With specific reference to FIG. 2, illustrated is another view of the elevator system 20 including an elevator car 30 that travels in hoistway 22. Elevator car 30 is guided by one or more guide structure 39 extending along the length of hoistway 22, where the guide structure 39 may be affixed to hoistway wall, a propulsion device, or stacked over each other. The view of FIG. 2 only depicts a single side guide structure 39; however, there may be two or more guide structure 39 positioned, for example, on opposite sides of the elevator car 14. The same placement variations apply to vertical propulsion stationary portion 36 placed in the hoistway 22. Vertical propulsion stationary portion 36 includes multiple segments affixed to hoistway wall, guide structure, or stacked over each other. Moving portion 38 of the propulsion system 35 may be affixed to a car frame or be a structural member of a car frame. A number of propulsion moving portions 38 may be placed on a car 30.

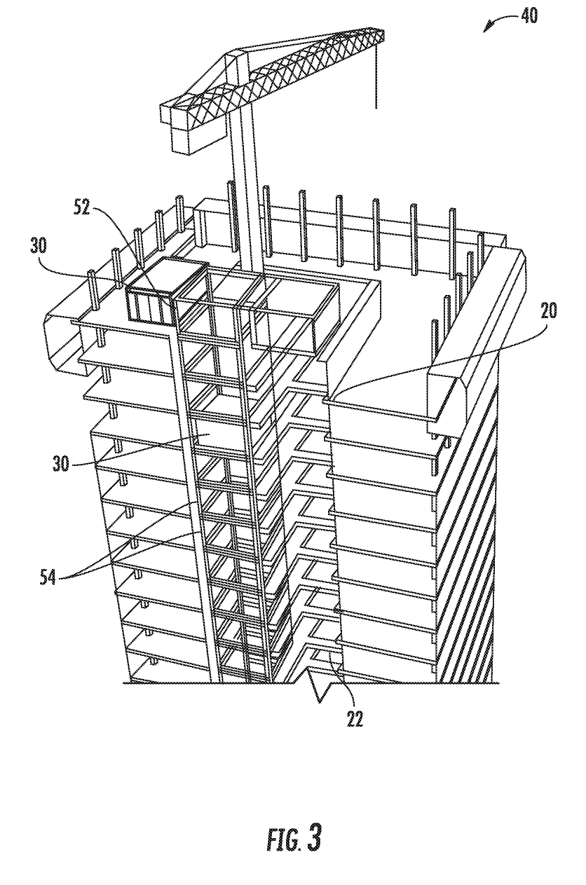

With reference now to FIG. 3, and continued reference to FIGS. 1 and 2, an example of a partially constructed building 40 is illustrated. As shown, the building 40 includes a partially constructed multicar, ropeless elevator system 20. Unlike conventional elevator systems which typically require a building structure to be substantially complete before starting installation of the elevator system, the multicar, ropeless elevator system 20 may be constructed substantially simultaneously or even in advance of the corresponding floors of a building 40. In an embodiment, the multicar, ropeless elevator system 20 includes a plurality of prefabricated modules 50. Vertical stacking of the modules 50 forms a mounting template that defines one or more lanes 24, 26, 28 within the hoistway 22 of the multicar, ropeless elevator system 20. Each lane 24, 26, 28 within the building generally includes at least one transfer station module 52 and one or more lane modules 54. In embodiments including a plurality of lane modules 54, the plurality of lane modules 54 may be substantially identical, or may be different. For example, one of the plurality of lane modules 54 may have a height different than the remainder of the plurality of lane modules 54.

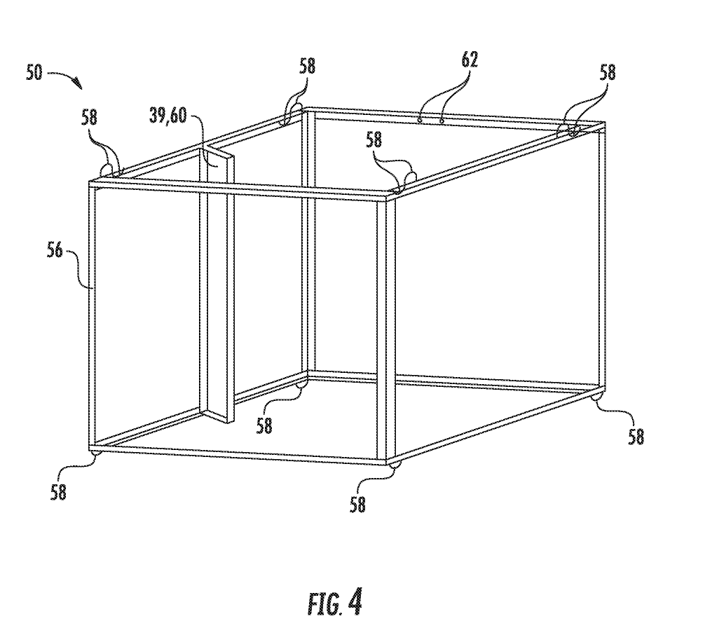

With reference now to FIG. 4, an example of a module is illustrated in more detail. As shown, the modules 50 include a structural frame 56 formed by a plurality of connected vertically and horizontally extending members. In an embodiment, each module 50 of the system 20 is associated with one of the plurality of floors of the building 40. As a result, when the module 50 is positioned within the hoistway 22, the structural frame 56 of the module 50 has a size, and more particularly a height, complementary to the floor of the building 40 associated therewith. For example, in such embodiments, a first end of the module 50 is substantially aligned with the landing of the floor, and a second, opposite end of the module is substantially aligned with a ceiling of the floor. However, embodiments where a single module 50 is associated with a plurality of floors, i.e. have a height greater than a single floor of the building, or is arranged at a position offset from a landing of the floor, or embodiments where multiple modules 50 may be associated with a single floor are also contemplated herein.

In an embodiment, one or more pieces of the structural frame 56 may be temporary. These temporary pieces are included in the prefabricated structure frame 56 when the module 50 is positioned within the hoistway 22. However, after one or more components associated with the module 50 have been installed, for example the guide rail or the stationary portion of the linear propulsion system 35, the one or more pieces are then removed from the hoistway 22 and/or the building 40. In an embodiment, the entire structural frame 56 may be temporary. Alternatively, or in addition, one or more pieces of the structural frame 56 may be permanent, meaning that they remain within the hoistway during completion and operation of the elevator system. In such embodiments, the permanent pieces of the structural frame 56 may be configured to attach to a part of the building structure, such as via fasteners for example. This connection between the structural frame 56 and the building 40 is intended to share the loads acting on the structural frames 56 with the structure of the building 40. In another embodiment, the entire structural frame 56 may be permanent.

Each module 50 additionally includes one or more module alignment features 58. To ensure proper alignment between adjacent modules 50, the module alignment features 58 are configured to interact with the module alignment features 58 of an adjacent module 50. In some embodiments, the module alignment features 58 of adjacent modules 50 are configured to engage and interlock, thereby connecting and locking modules 50 together in proper vertical and/or horizontal alignment.

One or more systems critical to operation of the elevator system 20 extend over a portion or the entire length of the hoistway 22. These systems include, but are not limited to, a guidance system, a control system, a propulsion system, and a power system. In an embodiment, each module 50 includes at least one component or feature 60 associated with one or more of these systems. For example, a guiding structure 39 and/or stationary portion of the linear propulsion system 35, may be integrated with the module 50. Alternatively, or in addition, conduits for receiving wires associated with the control and power systems, or part of the fixed portion of the propulsion system may be integrated with the module 50. As a result, when adjacent modules 50 are stacked in vertical alignment, the components 60 connected thereto will be arranged at a desired location within the hoistway 22. Further, in embodiment where adjacent components 60, such as portions of the guide rail for example, are configured to couple to one another, the components 60 are pre-aligned to facilitate installation over a length of the hoistway 22.

In place of the actual components 60 associated with the guidance system, control system, propulsion system, and power system, the module 50 may include one or more component alignment features 62 configured to clearly identify the correct position of such components 60 when mounted within the hoistway 22. Inclusion of these component alignment features 62 may ensure not only proper positioning within the lane or hoistway 22, but also the alignment between adjacent components 60.

Through the use of stackable modules, positionable via a crane or other lifting mechanism, one or more lanes 24, 26, 28 within a hoistway 22 can be built as the structure of the building 40 is constructed. Further, because multi-car, ropeless elevator systems 20 do not require a machine room arranged at the top of the hoistway 22 or a plurality of tension members for moving the elevator car 30 through the hoistway 22, the elevator cars 30 may be selectively operable to move within the stacked and assembled modules of the hoistway 22 during the construction of the elevator system 20. As a result, the elevator car 30 may be used to move at least a portion of the components associated with the installation of the elevator system or the construction of the building. The elevator cars 30 may be moved between the lanes 24, 26, 28 via a transfer station, or alternatively, may be inserted into a lane 24, 26, 28 from an external source, such as via a crane or forklift for example. In addition, the transfer modules 52 may be used to transfer an elevator car 30 from a lane 24, 26, 28 to an adjacent parking area where construction equipment can be unloaded from or loaded into the car 30. As a result, multiple cars 30 can travel into and out of the transfer module 52 during construction of the elevator system 10 and building 40.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

What is claimed is:

1. An elevator system for a building having a plurality of floors comprising:
a hoistway having one or more lanes, said one or more lanes being defined by a plurality of modules, each of said plurality of modules being associated with at least one of the plurality of floors, said plurality of modules being stacked relative to one another;
wherein each of said plurality of modules is installable within the building prior to construction of said at least one floor associated therewith, at the same time as construction of said at least one floor associated therewith, or after construction of said at least one floor associated therewith.

2. The elevator system of claim 1, wherein each of said plurality of modules is associated with a single floor of said plurality of floors.

3. The elevator system of claim 1, wherein each of said plurality of modules is associated with two or more floors of said plurality of floors.

4. The elevator system of claim 1, further comprising at least one elevator car is moveable within said one or more lanes.

5. The elevator system of claim 4, wherein said elevator car is moveable in a single vertical direction within at least one of said one or more lanes.

6. The elevator system of claim 4, further comprising a propulsion system for moving said at least one elevator car within said at least one lane, said propulsion system includes a primary portion mounted within said hoistway and a secondary portion coupled to said at least one elevator car, wherein said primary portion is positioned within the hoistway via said plurality of substantially aligned modules.

7. The elevator system of claim 4, wherein said at least one elevator car is movable within an installed portion of said plurality of modules during construction of the elevator system, said installed portion including less than said entire plurality of modules.

8. The elevator system of claim 1, wherein said plurality of modules includes at least one transfer station module and at least one lane module.

9. The elevator system of claim 1, wherein each of said plurality of modules includes a structural frame, a portion of said structural frame being a temporary structure.

10. The elevator system of claim 1, wherein each of said plurality of modules includes a structural frame, a portion of said structural frame being a permanent structure affixed directly to a structure of the building.

11. A module for constructing a lane of an elevator system in a building comprising:
a plurality of vertically and horizontally extending members connected to form a structural frame of a predetermined size;
at least one alignment feature associated with said structural frame, said at least one alignment feature being configured to align the module within a hoistway of the elevator system; and
at least one feature associated with a propulsion system, a control system, a guidance system, and a power system of the elevator system.

12. The module of claim 11, wherein said at least one feature of the module is shared with an adjacent module.

13. The module of claim 11, wherein said at least one feature includes a component arranged at a predetermined position relative to said structural frame.

14. The elevator module of claim 11, wherein said at least one feature indicates a position for installing one or more components associated with the elevator system relative to the structural frame.

15. A method of installing an elevator system having a lane defined by a plurality of modules within a building, the method comprising;
installing a portion of the plurality of modules within the building, said portion of the plurality of modules including at least one lane module and at least one transfer station module, said portion of the plurality of modules being substantially aligned;
installing at least one elevator car within said installed portion of the plurality of modules; and
moving said at least one elevator car through said installed portion of the plurality of modules.

16. The method of claim 15, wherein said at least one elevator car is inserted into said installed portion of the plurality of modules from outside the elevator system.

17. The method of claim 15, further comprising moving said at least one elevator car out of the lane.

18. The method of claim 17, wherein said at least one transfer station module is configured to move said at least one elevator car out of the lane, said at least one transfer station module being positioned at a central portion of the lane.

19. The method of claim 15, wherein moving said at least one elevator car through said installed portion of the plurality of modules transfers one or more components associated with the installation of the elevator system or the construction of the building to a desired location.

20. The method of claim 15, further comprising moving said at least one elevator car from within the installed portion of the plurality of modules into a parking area arranged adjacent the lane.
